(19) United States
(12) Patent Application Publication
(10) Pub. No.: US 2009/0142570 A1
(43) Pub. Date: Jun. 4, 2009

(54) Koil kushion

(76) Inventors: Thomas C. Boylan, Aliquippa, PA (US); Michael A. Dent, New Kensington, PA (US)

Correspondence Address: American Industrial Felt & Supply;Building 239, Schreiber Industrial Park, 12th Street, New Kensington, PA, 15068, US

(21) Appl. No.: 11/999,231

(22) Filed: Dec. 4, 2007

(51) Int. Cl. B32B 7/00

(52) U.S. Cl. 428/221

(57) ABSTRACT

A surface protection devise placed between a coil of ferrous or non-ferrous coiled material and the floor or substrate it is placed upon. This lightweight protective device, is constructed of polymer treated felts, and is used to hold, protect and cushion a coil while staging or in storage. This device consists of a base felt with two side rail felts mounted on top of the base felt, to provide an annulus between the mounted side rail felts. The device can be utilized in the rails up position, or turned over in a rails down position.

### CROSS REFERENCES TO RELATED APPLICATIONS

| | | |
|---|---|---|
| 4291845 | Sep. 29, 1981 | Van Cleave |
| 4592518 | Jun. 3, 1986 | Chubb |
| 4854792 | Aug. 8, 1989 | Cottone |
| D347567 | Jun. 7, 1994 | Duffy |
| 5660277 | Aug. 26, 1997 | Bostic |
| 6131975 | Oct. 17, 2000 | Simpson |
| 6783833 | Aug. 31, 2004 | Bordner |

### BACKGROUND OF THE INVENTION

1. Field of the Invention

The present invention relates to a surface protection device, that separates ferrous and non-ferrous coils from the floor or substrate it rests upon.

In the past, steel producers did not concern themselves with scrap or the finished quality of the coiled materials they produced. They would typically lay a coil on the concrete or wood floor, until needed by a customer. The coil was subject to marring and imperfections from lying on the floor. During this period of time, the cost to produce steel was somewhat inexpensive. Energy costs were low and there was not much competition, nor were the manufacturers producing specialized alloys of steel or aluminum. Scrap or marred coils would simply be funneled back through the melting process and made new.

Today, the steel industry has become very specialized in the production of coil products for original equipment manufacturers use. In most cases these coils have critical surfaces that need protected, prior to being shipped to a processor. These critical surfaces, which might be produced of stainless steel, titanium, nickel plated steel, aluminum or painted metal, have become very expensive to produce. Consequently, the producers are taking any steps possible to eliminate damage to their products.

Producers of steel products have experimented with various items to place between the coil and the floor or substrate they rest it upon. These items would include anything from cardboard to sophisticated urethane molded pads, to used rubber conveying belts. These devices served no protection to the coil, and are cumbersome, heavy, have limited lengths and widths, and are difficult to use. They typically function as a holder, not a protection device.

The benefits of the “Koil Kushion” is that it provides a cushioning affect for the coils, is lightweight and can be designed for various weights and sizes of coils. The “Koil Kushion” felts, treated properly with the correct polymer, can act as a corrosion inhibitor in highly humid areas or can be sealed completely to prevent oils or moisture from passing through. They can be made to any length and width, allowing each customer to customize their staging and storage areas, prior to shipment.

2. Description of the Related Art Including Information Disclosed Under 37 CFR 1.97 and 1.98

Floor coil holders have been used in the steel producing and processing industry for quite a long time. These forms of holders were usually made of wood, cardboard, solid urethane or even steel. While each has its' own attributes, they all are either cumbersome, heavy, hard to move, degradable, and even a small pebble on any of these past devices can leave an impression in the outer layers of the steel coil, causing waste, scrap and additional handling costs.

The “Koil Kushion” eliminates the problems associated with the past devices. Koil Kushions are light weight, easy to move, non-degradable and cushion the coil rather than just hold it in place. If a stone or pebble would happen to land on the Koil Kushion, it is compressed into the felt and does not transfer the mark or impression on to the coil. Additionally, the Koil Kushion is treated with various polymers to give it enhanced characteristics, such as anti-corrosive features.

### BRIEF SUMMARY OF THE INVENTION

The present invention, the “Koil Kushion” is designed to provide a surface protection device for ferrous and non-ferrous coils, from floor damage during staging and storing. This surface protection devise is made of a polymer treated felt base pad, with two top polymer treated side rails of felt; used underneath heavy objects, such as but not limited to steel and aluminum coils, to cushion the object and protect it from possible floor damage beneath.

The device is assembled in two layers, which include a base felt and two side-rail felts. The side rail felt is positioned and assembled along both longitudinal lengths of the base felt, creating a cradle between the rails, which allow for objects to rest in between the side-rails. The device may be used with the rails in the up position or with the rails in the down position.

Ferrous and non-ferrous coils alike come in various weights and sizes. Therefore various densities, lengths, widths and thicknesses of both felt components, combined with polymers, such as, but not limited to, urethanes, epoxies, silicates and acrylics, and having appropriate durometer, provide the composite benefits needed to protect, hold and cushion each coil.

### BRIEF DESCRIPTION OF THE DRAWINGS

On our drawing sheet, 1 of 1, it shows four (4) figures of reference.

FIG. 1 represents the top view, looking down on the device. It shows two (2) side rail felts, affixed to the base felt creating an opening between the two rail felts, on top of the base felt.

FIG. 2 represents the side view of the device. This figure shows how the rail felt is affixed to the base felt.

FIG. 3 represents an end view of the device. This view shows the height dimensional difference of the rail felt in relation to the base felt and also shows the opening created by the rail felts mounted on top of the base felt.

FIG. 4 represents a perspective of how a coil would rest upon the Koil Kushion, when the Koil Kushion is used with the rail felt in the up position and the rail felt in the down position.

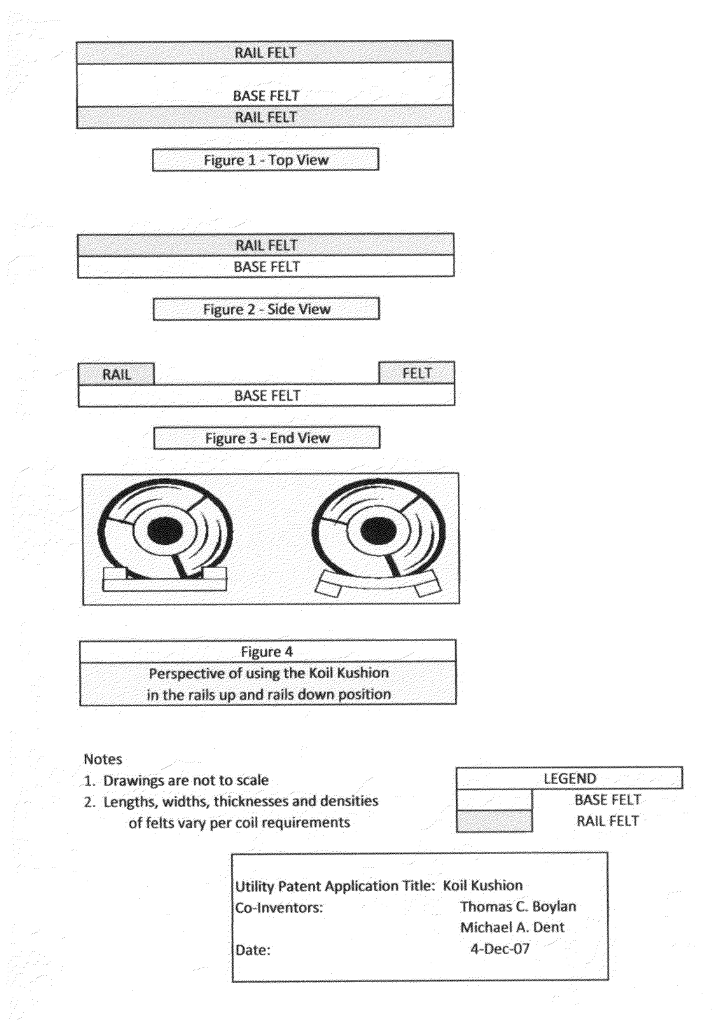

### DETAILED DESCRIPTION OF THE INVENTION

The present invention relates to a surface protection device, which is utilized as a protective cushion between a ferrous or non-ferrous coil and the floor or substrate it rests upon.

This invention utilizes a felt product, either natural or synthetic. Felts in general, come in different widths, lengths, thicknesses and densities.

This invention utilizes a base felt and a rail felt. Depending on the size and weight of the coil, the base felts will be sized to properly cushion the coil, and the rail felts will be properly sized to help hold the coil in place. For instance, a 60,000 pound coil having a six foot diameter would require a larger base felt and rail felt than a coil weighing 5,000 pounds and having a three foot diameter.

Once the proper base felt and rail felt are determined, the felt is cut to the dimensions that will adequately cushion and protect the selected coil size. After the felts are cut, they are prepared for polymer treatment.

This invention allows for the combination of various polymers to be added to the felt, such as, but not limited to, urethanes, epoxies, silicates or any other polymer which may enhance the characteristics of the felts. Such characteristics may include anti-rust inhibitors, moisture and oil pass-through protection, added strength, added flexibility and elevated temperature properties.

For polymer treatment, the base felt and the rail felt may be pre-assembled and treated, or they may be treated separately, and assembled after the polymer has cured. These determinations are usually decided upon by the size, weight, and thickness of the protection device. The protection device may be treated with a polymer or polymers in several manners, the most common being submerged in the polymer, allowing the protection device to become saturated, allowing the excess polymers to be rung out or drip dried. The product is then allowed to cure naturally in the open air, or it can be cured in curing oven.

Another manner of treatment would be to spray, roll or brush on a polymer coating. This method would allow for a controlled amount of polymer to be added to the felt and is typically used in small applications. Curing can be achieved through air or oven drying.

After the cure cycle is finalized, and if the device is not pre-assembled prior to the polymer treatment process, a like polymer used in the treatment may be used to mate and assemble all the parts to form the protection device.

1. A surface protection and holding device, for providing a protective cushioning layer between a ferrous and/or non-ferrous coil and any floor surface or substrate the coil would rest upon.

2. This devise, as claimed in claim number 1, is constructed and assembled of a wide base felt and two thinner rail felts, both located on the edges on the top side of the base felt. The base and rail felts may be of any width, length, thickness or density, as properly designed to hold and protect each and every different size coil.

3. The rail felts, as claimed for the device in claim number 2, are placed along the longitudinal edges of the base felt, to create an opening between the two rail felts, and on top of the base felt for the coil to rest.

4. The felts, as described for the device in claim number 2, may be manufactured of any wool or synthetic, such as polyester, nylon or any other natural or synthetic felt materials.

5. The felts, as described for the device in claim number 2, are coated or saturated with a polymer, such as urethane, epoxy, silicates or any other such polymer that enhances the characteristic of the felts, to protect and cushion the coil.

6. The addition of polymers to the felts, as claimed in claim number 5, are capable of providing various improvement characteristics to the felts, such as strength, longevity, anti-corrosion, flexibility, cushioning and anti-absorption qualities, that felts on their own do not provide or possess.
